(19) United States
(12) Patent Application Publication
(10) Pub. No.: US 2017/0220656 A1
(43) Pub. Date: Aug. 3, 2017

(54) Information Access System

(71) Applicant: ADP, LLC, Roseland, NJ (US)

(72) Inventors: Kuntal Roy, North Brunswick, NJ (US); Cory Parrish, West Orange, NJ (US); Nikhil Prabhakar, New York, NY (US); Jason F. Melo, Hastings-on-Hudson, NY (US)

(21) Appl. No.: 15/014,322

(22) Filed: Feb. 3, 2016

(51) Int. Cl. G06F 17/30

(52) U.S. Cl. CPC G06F 17/30569; G06F 17/30554; G06F 17/303; G06F 17/30312; G06F 17/30377

(57) ABSTRACT

A method and apparatus for accessing information stored in a key value database. The method comprises receives, by a computer system, a request from a client device to access the information in the key value database in a storage system for the computer system. Further, the method comprises identifies, by the computer system, a structure for the information from the request. Yet further, the method comprises creates, by the computer system, a relational database having the structure identified from the request. Further, the method comprises places, by the computer system, the information for the client device in the relational database, wherein the relational database is located in a memory, wherein the relational database in the memory is accessed by the client device, enabling access to the information in the key value database by client devices that access relational databases with different relational database structures.

### BACKGROUND INFORMATION

1. Field

The present disclosure relates generally to an improved computer system and, in particular, to a method and apparatus for accessing information in a database on a server computer system. Still more particularly, the present disclosure relates to a method and apparatus for accessing information in a database on a server computer system using applications on client devices.

2. Background

The Internet is a global system of computer networks that are connected to each other. These computer networks communicate using an Internet protocol suite (TCP/IP). These networks include private, public, academic, business, and other types of networks across the world. The Internet carries many types of information in different forms. For example, webpages, documents, applications, messages, e-mails, invoices, ordering information, voice, multimedia, and other types of information may be carried out on the Internet.

These and other types of information may be accessed using applications on client devices. For example, a client device, such as a tablet, may use one or more web applications to access payroll information, banking information, benefits information, research, or other suitable types of information.

A web application is a client-server software application in which the client runs the web application in a web browser. Information is stored on a server computer by a provider of the information. Information may be stored in a database accessed by the web application.

Multiple users may access information from the provider. The different users may have different requirements as to what information and how information is stored or organized. For example, with payroll information, one user may only require a first name and a last name, while another user may require a first name, a middle initial, and a last name. As another example, one user may include geographic locations of employees while another user may omit geographic locations of employees in a database. One user may format numbers differently from another user.

The information is typically stored in relational databases. This information is stored in tables that may be queried. A provider currently stores information in separate databases when users have different preferences, with respect to formatting or what information is stored.

Having more than one relational database results in increased maintenance. For example, the same maintenance may be performed from multiple databases taking more time and effort, as compared to having a single centralized database.

Further, with multiple databases, auditing databases is more difficult when information is needed from more than one database for the audit. For example, queries are developed and structured for each database to obtain the information needed for audits.

Additionally, a user may change the information stored, the formatting of the information, or some combination thereof. These changes result in the provider restructuring the relational database. For example, the provider may create a new relational database and export the information from the original relational database to the new relational database. Alternatively, the provider may alter the structure of the existing relational database to include the new information or the new format. With formatting, existing data may be reformatted to meet the new format. This process of restructuring relational databases may take more time and effort than desired.

Therefore, it would be desirable to have a method and apparatus that take into account at least some of the issues discussed above, as well as other possible issues. For example, it would be desirable to have a method and apparatus that overcome a technical problem with having information accessed by users in multiple relational databases.

### SUMMARY

An embodiment of the present disclosure provides a method for accessing information stored in a key value database. The method comprises receiving, by a computer system, a request from a client device to access the information in the key value database in a storage system for the computer system. Further, the method comprises identifying, by the computer system, a structure for the information from the request. Yet further, the method comprises creating, by the computer system, a relational database having the structure identified from the request. Further, the method comprises placing, by the computer system, the information for the client device in the relational database, wherein the relational database is located in a memory, wherein the relational database in the memory is accessed by the client device, enabling access to the information in the key value database by client devices that access relational databases with different relational database structures.

Another embodiment of the present disclosure provides an information access system. The information access system comprises an information manager. The information manager receives a request from a client device to access information in a key value database in a storage system for a computer system. Further, the information manager identifies a structure for the information from the request. Yet further, the information manager creates a relational database having the structure identified from the request. Further, the information manager places the information for the client device in the relational database, wherein the relational database is located in a memory, wherein the relational database in the memory is accessed by the client device, enabling access to the information in the key value database by client devices that access relational databases with different relational database structures.

Yet another embodiment of the present disclosure provides a computer program product for accessing information stored in a key value database. The computer program product comprises a computer readable storage media, first program code, second program code, third program code, and fourth program code. The first program code, stored on the computer readable storage media, receives a request from a client device to access the information in the key value database in a storage system for a computer system. The second program code, stored on the computer readable storage media, identifies a structure for the information from the request. The third program code, stored on the computer readable storage media, creates a relational database having the structure identified from the request. The fourth program code, stored on the computer readable storage media, places the information for the client device in the relational database, wherein the relational database is located in a memory, wherein the relational database in the memory is accessed by the client device, enabling access to the information in the key value database by client devices that access relational databases with different relational database structures.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is an illustration of a block diagram illustrating data flow for accessing information in accordance with an illustrative embodiment;

FIG. 3 is an illustration of a block diagram illustrating dataflow for creating a relational database using information stored in a key value database with an illustrative embodiment;

FIG. 4 is an illustration of a key value database in accordance with an illustrative embodiment;

FIG. 5 is an illustration of a relational database in accordance with an illustrative embodiment;

FIG. 6 is an illustration of a flowchart of a process for accessing information stored in a key value database in accordance with an illustrative embodiment;

FIG. 7 is an illustration of a flowchart of a process for processing queries in accordance with an illustrative embodiment;

FIG. 8 is an illustration of a flowchart of a process for creating a relational database from information in a key value database in accordance with an illustrative embodiment;

FIG. 9 is an illustration of a flowchart of a process for processing a query to change information in accordance with an illustrative embodiment;

FIG. 10 is an illustration of a flowchart of a process for managing information from a key value database in multiple relational databases in accordance with an illustrative embodiment; and

FIG. 11 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that having a single centralized database may reduce maintenance, increase the ease at which audits may be performed, increase performance, as well as provide other potential benefits.

The illustrative embodiments also recognize and take into account that having a single database for multiple users that uses at least one of different types of information or formats for information may be implemented using key value databases. As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The illustrative embodiments recognize and take into account that key value databases may provide centralization of information that may be different between different users. Those embodiments recognize and take into account, however, that many users use relational databases instead of key value databases.

As used herein, a user is a person or an organization that accesses information stored in a database offered by a provider. The provider is a person or an organization that operates the database. The organization takes various forms. For example, the organization may be a company, a partnership, a charity, an educational group, a social group, a team, a government entity, or some other suitable organization.

A relational database stores information in a predefined data structure. The relational database stores information in tables containing fields with defined types of data.

A key value database stores information in which a key is used to identify a piece of information. The key may directly or indirectly reference the piece of information. For example, the key may be a non-integer that is processed using a hash function to obtain an integer that is an index to the piece of information in an array. A key value database is also referred to as a non-sequential database.

Thus, the illustrative embodiments provide a method and apparatus for storing information for multiple users in a single key value database. Access to the information by different users is provided by generating a relational database that has a structure for the user.

A memory holds information for intermediate use in a computer system. The memory operates at a higher speed than a storage system. The memory is a primary storage, while the storage system is a secondary storage. For example, the memory is directly accessed by a processor unit, while the storage system is an external device to the processor unit.

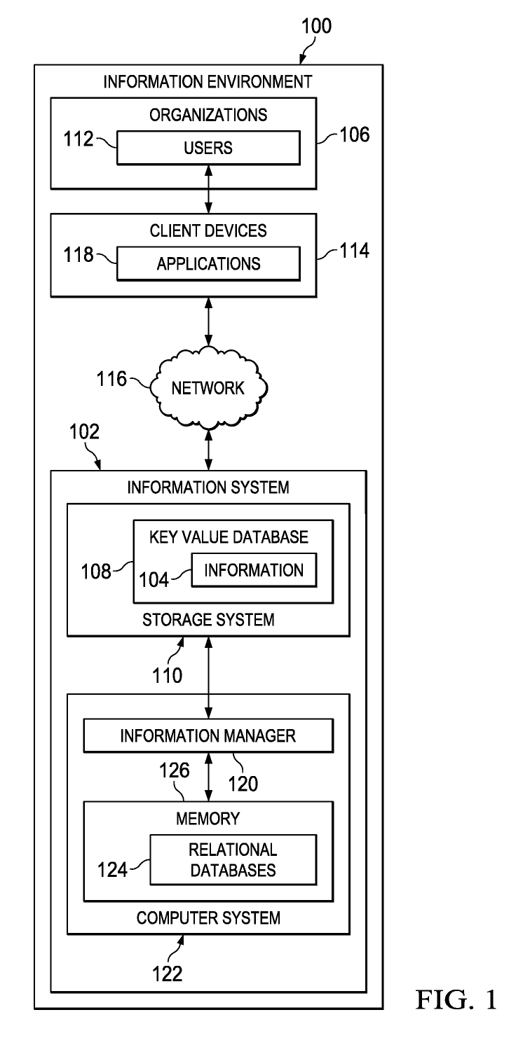

With reference now to the figures, and in particular, with reference to FIG. 1, an illustration of a block diagram of an information environment is depicted in accordance with an illustrative embodiment. In this illustrative example, information environment 100 includes information system 102. Information system 102 manages information 104 for one or more of organizations 106. Information 104 is stored in key value database 108 in storage system 110. In other words, key value database 108 is a central storage system for organizations 106.

As depicted, organizations 106 may include, for example, at least one of a corporation, a partnership, a charitable organization, a city, a government agency, or some other suitable type of organization. Information 104 may include, for example, at least one of information about people, products, research, product analysis, business plans, financials, or some other type of information for organizations 106.

As depicted, users 112 in one or more of organizations 106 access information 104 using client devices 114. Client devices 114 are hardware and may include software. Client devices 114 may be selected from at least one of a desktop computer, a server computer, a tablet computer, a mobile phone, a laptop, a kiosk, or some other suitable type of client device.

Client devices 114 connect to information system 102 through network 116. Network 116 may include at least one of the Internet, an intranet, a local area network, a wide area network, or some other communications media.

Users 112 may use applications 118 on client devices 114 to access information 104. As depicted, applications 118 are software that runs on client devices. Applications 118 may be, for example, a web application, a program, a browser, or some other suitable type of application.

As depicted, access to information 104 is managed by information manager 120, which may be implemented in software, hardware, firmware, or a combination thereof. When software is used, the operations performed by information manager 120 may be implemented in program code configured to run on hardware, such as a processor unit. When firmware is used, the operations performed by information manager 120 may be implemented in program code and data and stored in a persistent memory to run on a processor unit. When hardware is employed, the hardware may include circuits that operate to perform the operations in information manager 120.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components, and may be comprised entirely of organic components, excluding a human being. For example, the processes may be implemented as circuits in organic semiconductors.

As depicted, information manager 120 may be located in computer system 122 within information system 102. Computer system 122 is a hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

As depicted, information manager 120 creates relational databases 124. Relational databases 124 hold some or all of information 104 stored in key value database 108. In other words, relational databases 124 are copies of some or all of information 104 stored in key value database 108 in a different structure from key value database 108. Relational databases 124 are placed into memory 126 for access by client devices 114.

In this illustrative example, memory 126 is a physical hardware device that stores information, such as information 104, in relational databases 124. Memory 126 stores this information for immediate use in computer system 122.

Memory 126 is a primary storage, such as a random access memory. Memory 126 is in contrast to secondary storage that provides slower access. A secondary storage may be, for example, a hard disk drive, a solid state disk drive, or some other type of storage device.

In information environment 100, information manager 120 provides an ability for each user in users 112 using an application in applications 118 on a client device in client devices 114 to interact with a specific portion or subset of information 104 in a relational database in relational databases 124. As depicted, each specific application may have a different selection of information 104 from other applications in applications 118.

For example, an accounting application may use different information in information 104 as compared to a human resources application or a marketing application in applications 118. Each one of applications 118 accesses a copy of information 104 from key value database 108. With a separate copy for each application, conflicts may be avoided between applications accessing relational databases 124.

Additionally, the same portion of information 104 may be accessed by a plurality of applications 118. For example, a relational database may be created for each of the plurality of applications 118, or the plurality of applications 118 may access the same relational database, depending on the particular implementation.

For example, one of applications 118 may be allowed to change the portion of information 104, while the other ones in the plurality of applications 118 only have read-only access to the portion of information 104. One of applications 118 may receive a copy of the portion of information 104 with full access, while other ones of applications 118 may receive copies of the portion of information 104 with a read-only access.

In yet another illustrative example, the read-only access may be implemented temporarily when one of applications 118 requires an access to change the portion of information 104. This type of access may be implemented using locks. Changes may be propagated to the other copies of applications 118 by information manager 120 in the illustrative example.

In other illustrative examples, the plurality of applications 118 may all be able to change in the portion of information 104. This type of change may occur in a sequential manner based on when the different changes were made.

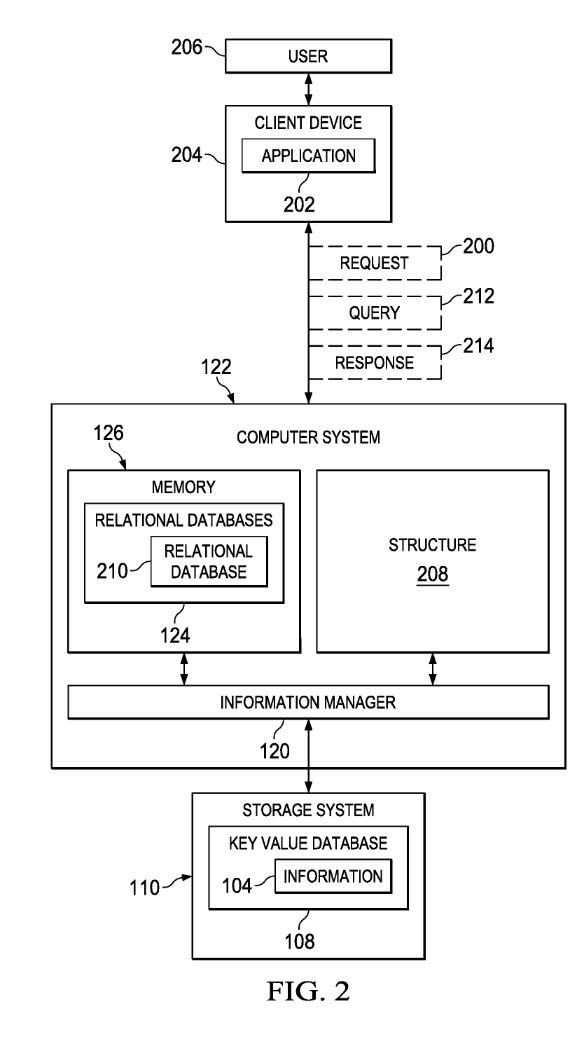

With reference now to FIG. 2, an illustration of a block diagram illustrating data flow for accessing information is depicted in accordance with an illustrative embodiment. In the illustrative examples, the same reference numeral may be used in more than one figure. This reuse of a reference numeral in different figures represents the same element in the different figures.

For example, information manager 120 receives request 200 from application 202 on client device 204 that is operated by user 206 to access information 104 in key value database 108 in storage system 110 for computer system 122. In this illustrative example, user 206 is a user in users 112; client device 204 is a client device in client devices 114; and application 202 is an application in applications 118 as shown in block form in FIG. 1.

As depicted, request 200 identifies structure 208 for information 104 from request 200. In this illustrative example, request 200 may include an identification of structure 208, information that may be used to identify or generate structure 208, or some combination thereof.

Information manager 120 creates relational database 210 in relational databases 124 having structure 208 identified from request 200 in computer system 122. Information manager 120 places information 104 for client device 204 in relational database 210. Relational database 210 in memory 126 is accessed by client device 204, enabling access to information 104 in key value database 108 by client devices 114 that access relational databases 124 with different relational database structures.

For example, application 202 may send query 212. Information manager 120 uses query 212 to identify information 104 for placement into response 214. Information manager 120 returns response 214 to application 202 on client device 204.

In one illustrative example, one or more technical solutions are present that overcome a technical problem with having information accessed by users in multiple relational databases. As a result, one or more technical solutions may provide a technical effect providing access to information stored in a key value database to client devices that expect to access relational databases.

As a result, computer system 122 operates as a special purpose computer system in which information manager 120 in computer system 122 enables access to information 104 stored in key value database 108 by client devices 114 that are configured to access relational databases with particular structures. In particular, information manager 120 transforms computer system 122 into a special purpose computer system, as compared to currently available general computer systems that do not have information manager 120.

Computer system 122 performs a transformation of information 104 such that information 104 may be accessed by client devices 114 without client devices 114 changing the manner in which client devices 114 access information 104. For example, computer system 122 transfers information 104 from a format as stored in key value database 108 into a form for use in relational databases 124. As depicted, key value database 108 has pairs of information 104 in key value database 108 that may be obtained and placed into appropriate locations in tables within relational databases 124. Thus, when a copy of information 104 is placed into relational databases 124 and memory 126, information 104 has a different structure or form that is usable by applications 118 in client devices 114 in FIG. 1.

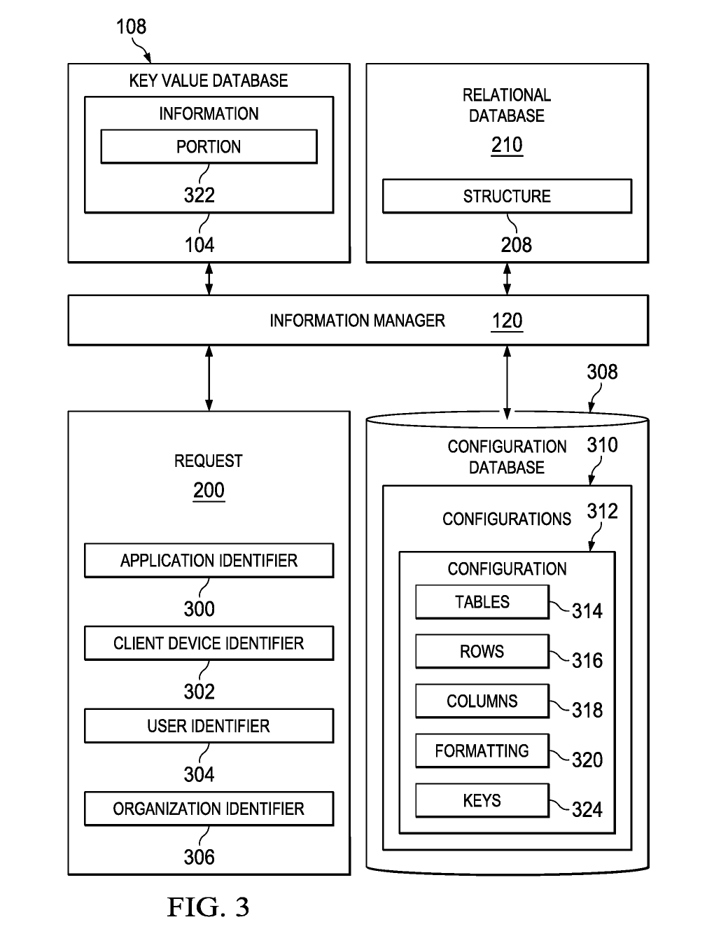

With reference now to FIG. 3, an illustration of a block diagram illustrating dataflow for creating a relational database using information stored in a key value database is depicted in accordance with an illustrative embodiment. In this example, request 200 includes at least one of application identifier 300, client device identifier 302, user identifier 304, organization identifier 306, or other suitable information. This information in request 200 is used to identify structure 208 and what portions of information 104 in key value database 108 should be used to create relational database 210.

As depicted, application identifier 300 is an identification of application 202 in FIG. 2. Client device identifier 302 identifies client device 204 in FIG. 2. User identifier 304 identifies user 206 in FIG. 2. Organization identifier 306 identifies an organization.

As depicted, request 200 is used to identify structure 208. This identification is made using configuration database 308. Configuration database 308 contains configurations 310 for creating structures for relational databases.

In this illustrative example, a particular configuration may be identified using at least one of application identifier 300, client device identifier 302, user identifier 304, or organization identifier 306 in request 200. These identifiers may be used as indexes to identify a particular configuration. For example, a particular type of application may have a selected configuration for structure 208.

As another example, a particular user identified by user identifier 304 may have defined structure 208. In another illustrative example, structure 208 may be based on the type of client device identified by client device identifier 302. In yet another illustrative example, an organization may be assigned structure 208.

In this illustrative example, configuration 312 in configurations 310 is the configuration identified for structure 208. As depicted, configuration 312 includes tables 314, rows 316, columns 318, and formatting 320. Tables 314, containing rows 316 and columns 318, are identified in configuration 312 as tables that are used in structure 208.

Formatting 320 is for the formatting of information 104 that is placed into structure 208. For example, formatting 320 may define formatting for each of columns 318. As depicted, formatting 320 may include at least one of data type, size, font, color, or other types of formatting of information 104 to be placed into structure 208. For example, when application identifier 300 is for an expense application, tables 314, rows 316, and columns 318 are different than those when application identifier 300 is for a human resource application.

With the identification of configuration 312 from request 200, information manager 120 creates structure 208. Information manager 120 also identifies portion 322 of information 104 in key value database 108. Information manager 120 places a copy of portion 322 of information 104 in key value database 108 and is placed into structure 208 to create relational database 210.

In this illustrative example, portion 322 also may be identified in configuration 312. For example, configuration 312 may include keys 324. In this illustrative example, keys 324 may be identified from request 200. For example, user identifier 304 may be used to identify keys 324 to identify portion 322 of information 104 for use in structure 208.

In this manner, keys 324 may be used to identify portion 322 of information 104 that is to be placed into structure 208 to form relational database 210. As depicted, portion 322 may be some or all of information 104 in key value database 108. In yet other illustrative examples, keys 324 may be generated from at least one of application identifier 300, client device identifier 302, user identifier 304, or organization identifier 306 in request 200.

The illustration of information environment 100 and the different components in information environment 100 in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

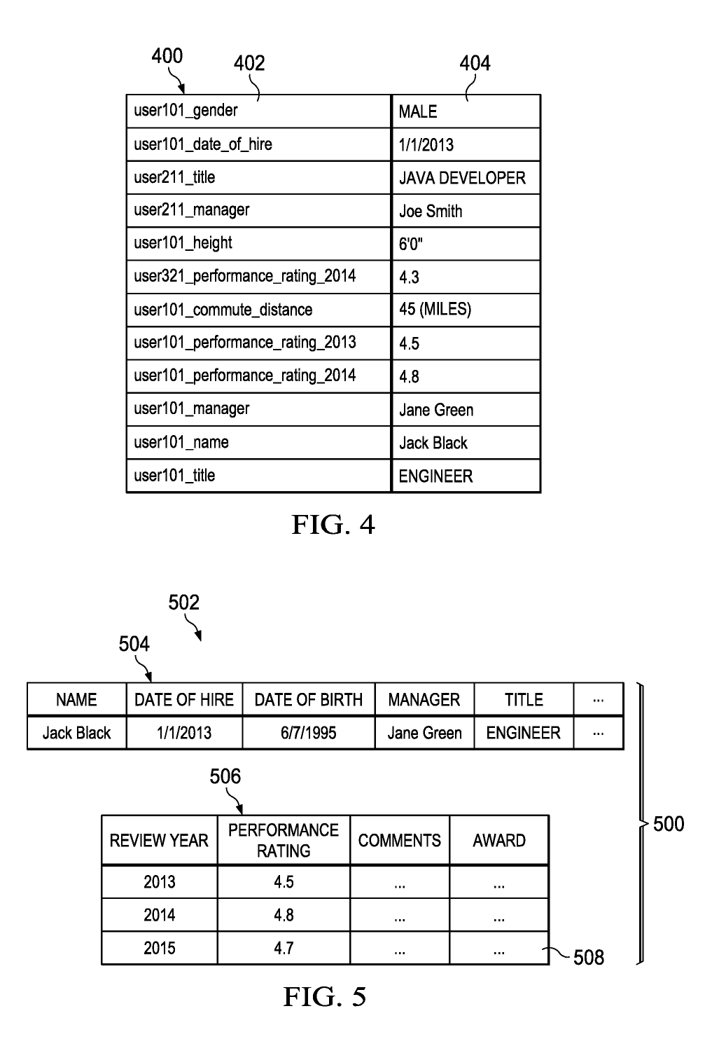

With reference next to FIG. 4, an illustration of a key value database is depicted in accordance with an illustrative embodiment. In this example, key value database 400 is an example of one implementation for key value database 108 shown in block form in FIG. 1. Key value database 400 stores information using key and value pairs. In this particular example, column 402 is the key value and column 404 is the value in key value database 400.

Key value database 400 stores information for at least one of different applications, users, organizations, or other purposes. In other words, all of this information may be stored in a single database rather than in multiple databases.

In this illustrative example, key value database 400 is not usable in the current form by an application on a client device. Instead, key value database 400 is used to create a relational database in a memory that is usable by the application. As depicted, a portion of key value database 400 is used to create a relational database using tables in a format usable by a client device. In this manner, applications may interact with one or more relational databases created in a memory from key value database 400.

Further, as applications are changed or new applications are added that access relational databases with different structures, those relational databases may be created from key value database 400. In this manner, more flexibility in allowing for changes in the structure of relational databases is present. With key value database 400, applications expecting different structures for relational databases may all be supported without requiring changes to the different applications.

With reference now to FIG. 5, an illustration of a relational database is depicted in accordance with an illustrative embodiment. In this illustrative example, tables 500 in relational database 502 are created using some of the information in key value database 400 in FIG. 4. Relational database 502 may be created using dataflow as shown in FIG. 3.

As depicted, tables 500 include table 504 and table 506. In this example, tables 500 are for a particular user whose information is located in key value database 400 in FIG. 4 with information for other users. The structure of tables 500 and the information placed into tables 500 are identified using the process described above in FIG. 3.

In this illustrative example, relational database 502 is stored in a memory. As depicted, a user may make changes to information in relational database 502. Changes to relational database 502 may be stored and used to update relational database 502.

For example, row 508 is a new row in table 506 that is created by the application for which relational database 502 was generated. The information in row 508 may be written into key value database 400 in FIG. 4. In another example, if a value is changed in a row in relational database 502, the change in the value may be written into key value database 400. Additionally, similar changes may be made when rows are deleted in tables 500.

These changes may be saved in a change table (not shown) that stores changes made to tables 500. The changes may include, for example, new rows, deleted rows, and changed rows. The change table may be used to make changes to key value database 400 in FIG. 4. These changes may be made based on an event, such as the application logging out of relational database 502, the passage of a period of time, or some other suitable event.

If the user logs into a new application, a different relational database may be generated from key value database 400 in FIG. 4 that is tailored for that particular application. The new application may result in different tables being generated from key value database 400 in this example.

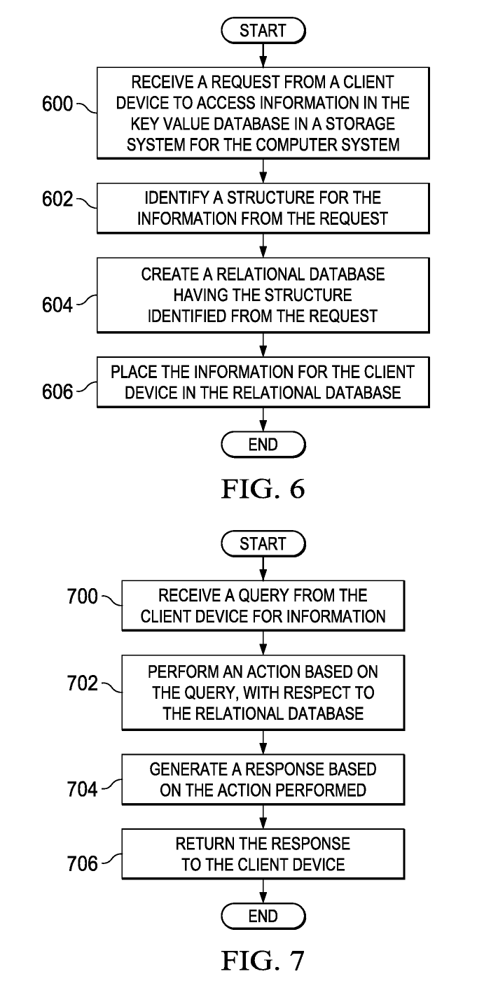

Turning next to FIG. 6, an illustration of a flowchart of a process for accessing information stored in a key value database is depicted in accordance with an illustrative embodiment. The process illustrated in FIG. 6 may be implemented in information environment 100 in FIG. 1. For example, the process illustrated may be implemented in information manager 120 in FIG. 1.

The process begins by receiving a request from a client device to access information in the key value database in a storage system for the computer system (step 600). The process identifies a structure for the information from the request (step 602).

Thereafter, the process creates a relational database having the structure identified from the request (step 604). The process then places the information for the client device in the relational database (step 606). The relational database is located in a memory. The relational database in the memory is accessed by the client device, enabling access to information in the key value database by client devices that access relational databases with different relational database structures.

Turning next to FIG. 7, an illustration of a flowchart of a process for processing queries is depicted in accordance with an illustrative embodiment. The process illustrated in FIG. 7 may be implemented in information environment 100 in FIG. 1 and, in particular, may be implemented using information manager 120 in FIG. 1.

The process receives a query from the client device for information (step 700). The process then performs an action based on the query, with respect to the relational database (step 702). The action may be selected from one of reading information, modifying information, or deleting information in the relational database.

The process then generates a response based on the action performed (step 704) and returns the response to the client device (step 706). The process terminates thereafter.

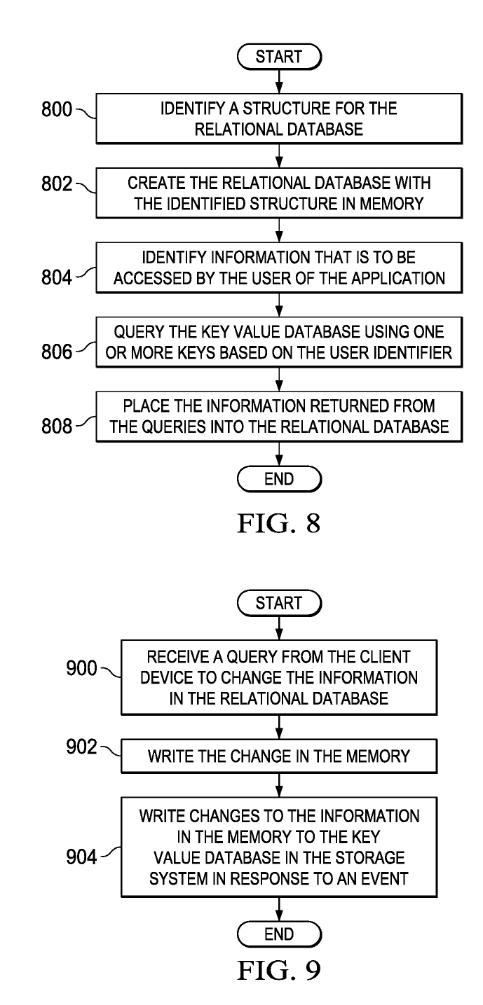

With reference now to FIG. 8, an illustration of a flowchart of a process for creating a relational database from information in a key value database is depicted in accordance with an illustrative embodiment. The process illustrated in FIG. 8 may be implemented in information manager 120 in FIG. 1.

As depicted, the process begins by identifying a structure for the relational database (step 800). An application identifier may be received in the request from the application to access the relational database. The structure in this example may be identified based on the identification of the application that will access the relational database. The process then creates the relational database with the identified structure in a memory (step 802). In creating the relational database, the process creates tables with rows and columns having formats based on the structure identified.

The process then identifies information that is to be accessed by the user of the application (step 804). A user identifier may be received in the request for access to the information. The user identifier may be used as a key or part of a key to identify the portion of the information that will be used by the application.

The process then queries the key value database using one or more keys based on the user identifier (step 806). The process then places the information returned from the queries into the relational database (step 808), with the process terminating thereafter.

Thus, the process creates the relational database having a structure that is accessible by the application requesting access to information in the key value database. As described, the structure of the relational database is based on the application. In other words, the relational database created has a structure that is expected by the application when sending queries to the relational database.

In creating the relational database, the database may remain in the memory for some period of time. For example, the relational database may remain in the memory for five minutes, ten minutes, one hour, two days, or some other period of time before being removed without access from the application.

Turning next to FIG. 9, an illustration of a flowchart of a process for processing a query to change information is depicted in accordance with an illustrative embodiment. The process illustrated in FIG. 9 may be implemented in information environment 100 in FIG. 1 and, in particular, in information manager 120 in FIG. 1.

The process begins by receiving a query from the client device to change the information in the relational database (step 900). The change may be, for example, at least one of writing new information, deleting information, or changing current information in the relational database. The process writes the change in the memory (step 902). In writing the change in the memory in step 902, the change may be made in the relational database, and also may store the change in the change table in the memory. The change table may be used to update the key value database. The process then writes changes to the information in the memory to the key value database in the storage system in response to an event (step 904), with the process terminating thereafter.

In the illustrative example, the effect may take various forms. For example, the effect may be a periodic event or a non-periodic event. A periodic event may be, for example, a period of time, such as ten minutes, twenty minutes, or some other period of time. The non-periodic event may be, for example, a client device logging off the relational database, a command received from the client device to store the changes, or some other suitable event.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

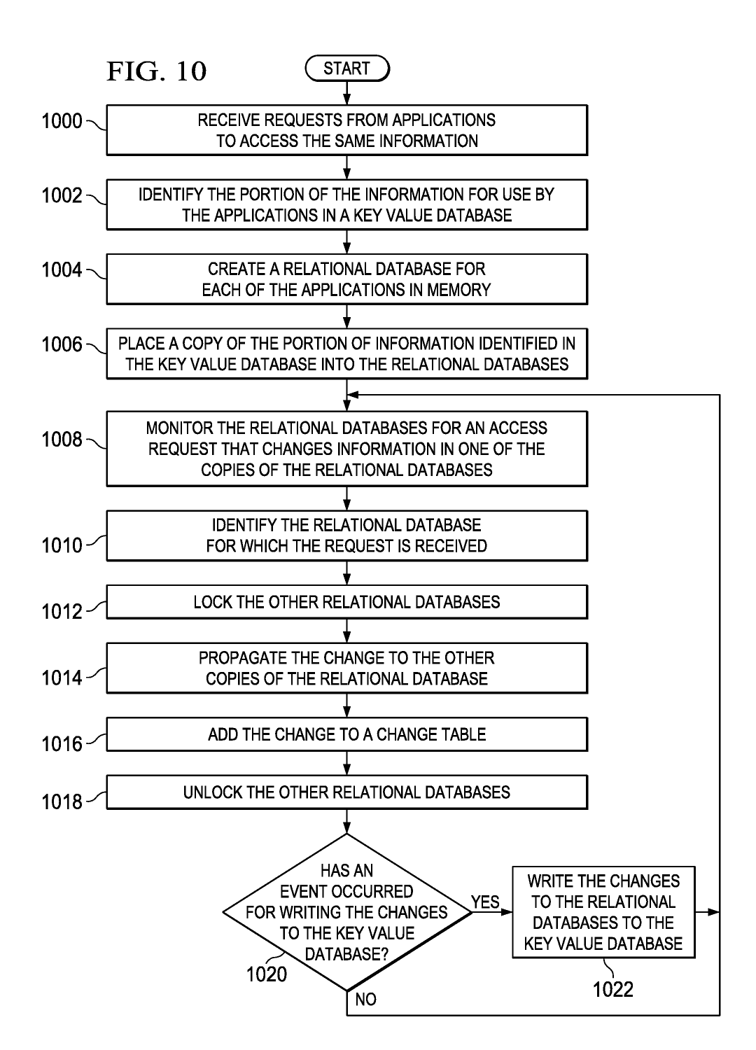

Turning next to FIG. 10, an illustration of a flowchart of a process for managing information from a key value database in multiple relational databases is depicted in accordance with an illustrative embodiment. The process illustrated in FIG. 10 may be implemented using information manager 120 as shown in block form in FIG. 1.

The process begins by receiving requests from applications to access the same information (step 1000). In this example, the applications are all of the same type. The applications may be, for example, payroll applications, human resources applications, benefits applications, marketing applications, or other suitable types of applications.

The process then identifies the portion of the information for use by the applications in a key value database (step 1002). The process then creates a relational database for each of the applications in the memory (step 1004). In this example, the relational databases have a structure that is usable by the applications, and the structure is identical for all of the relational databases.

The process then places a copy of the portion of information identified in the key value database into the relational databases (step 1006). Step 1006 creates a copy of the relational database for each one of the applications in the memory. The process then monitors the relational databases for an access request that changes information in one of the copies of the relational databases (step 1008).

When an access request to change information is received, the process identifies the relational database for which the request is received (step 1010). The process then locks the other relational databases (step 1012). This lock may be for a particular row, table, or the entire relational database, depending on the particular implementation. In this manner, the other relational databases cannot be changed in a manner that conflicts with the change requested.

The process then propagates the change to the other copies of the relational database (step 1014). The process adds the change to a change table (step 1016). The change table is a data structure that stores changes to the relational databases. In this manner, these changes may be propagated to the key value database when needed. The process then unlocks the other relational databases (step 1018).

A determination is made as to whether an event has occurred for writing the changes to the key value database (step 1020). The event may be, for example, the expiration of a period of time, an application logging out of one of the relational databases, a new application requiring the same information as in the current relational databases, or some other suitable event. For example, when a new application results in a new relational database with a copy of the information in the memory to be created, the key value database may be updated prior to creating the copy of the new relational database. This new relational database may be added to the relational databases being managed in this process.

If an event has occurred, the process writes the changes to the relational databases to the key value database (step 1022), with the process then returning to step 1008. The process also returns to step 1008 if an event has not occurred.

In this example, these different steps are implemented in information manager 120 in FIG. 1. Information manager 120 may operate in conjunction with processes to access the relational databases to avoid conflicts in the relational databases caused by applications changing information in the relational databases.

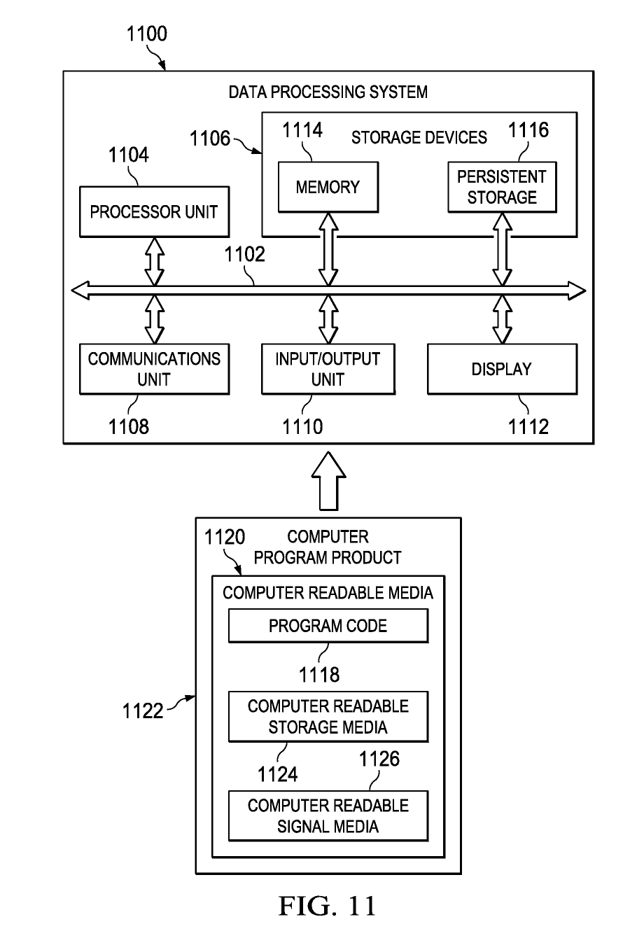

Turning now to FIG. 11, an illustration of a block diagram of a data processing system is depicted in accordance with an illustrative embodiment. Data processing system 1100 may be used to implement client devices 114 and one or more data processing systems in computer system 122 in FIG. 1. In this illustrative example, data processing system 1100 includes communications framework 1102, which provides communications between processor unit 1104, memory 1114, persistent storage 1116, communications unit 1108, input/output (I/O) unit 1110, and display 1112. In this example, communications framework 1102 may take the form of a bus system.

Processor unit 1104 serves to execute instructions for software that may be loaded into memory 1114. Processor unit 1104 may be a number of processors, a multi-processor core, or some other type of processor, depending on the particular implementation.

Memory 1114 and persistent storage 1116 are examples of storage devices 1106. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1106 may also be referred to as computer readable storage devices in these illustrative examples. Memory 1114, in these examples, may be, for example, a random access memory or any other suitable volatile or non-volatile storage device. Persistent storage 1116 may take various forms, depending on the particular implementation.

For example, persistent storage 1116 may contain one or more components or devices. For example, persistent storage 1116 may be a hard drive, a solid state hard drive, a flash memory, a rewritable optical disk, a rewritable magnetic tape, or some combination of the above. The media used by persistent storage 1116 also may be removable. For example, a removable hard drive may be used for persistent storage 1116.

Communications unit 1108, in these illustrative examples, provides for communications with other data processing systems or devices. In these illustrative examples, communications unit 1108 is a network interface card.

Input/output unit 1110 allows for input and output of data with other devices that may be connected to data processing system 1100. For example, input/output unit 1110 may provide a connection for user input through at least one of a keyboard, a mouse, or some other suitable input device. Further, input/output unit 1110 may send output to a printer. Display 1112 provides a mechanism to display information to a user.

Instructions for at least one of the operating system, applications, or programs may be located in storage devices 1106, which are in communication with processor unit 1104 through communications framework 1102. The processes of the different embodiments may be performed by processor unit 1104 using computer-implemented instructions, which may be located in a memory, such as memory 1114.

These instructions are referred to as program code, computer usable program code, or computer readable program code that may be read and executed by a processor in processor unit 1104. The program code in the different embodiments may be embodied on different physical or computer readable storage media, such as memory 1114 or persistent storage 1116.

Program code 1118 is located in a functional form on computer readable media 1120 that is selectively removable and may be loaded onto or transferred to data processing system 1100 for execution by processor unit 1104. Program code 1118 and computer readable media 1120 form computer program product 1122 in these illustrative examples. In one example, computer readable media 1120 may be computer readable storage media 1124 or computer readable signal media 1126. In these illustrative examples, computer readable storage media 1124 is a physical or tangible storage device used to store program code 1118, rather than a medium that propagates or transmits program code 1118.

Alternatively, program code 1118 may be transferred to data processing system 1100 using computer readable signal media 1126. Computer readable signal media 1126 may be, for example, a propagated data signal containing program code 1118. For example, computer readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

Thus, the illustrative embodiments provide a method and apparatus for accessing information stored in a key value database. One or more of the different illustrative examples provide a technical solution that overcomes a technical problem with having information accessed by users in multiple relational databases. A relational database may be generated having a structure for each particular application.

The structure may be identified through a configuration file, information received from the application, or some other manner. Thus, new applications or changes to existing applications that require different structures for relational databases used by the applications may occur without having to make changes to other applications or changes to the structure of how information is stored in the primary copy of the information in the key value database.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for accessing information stored in a key value database, the method comprising:
receiving, by a computer system, a request from a client device to access the information in the key value database in a storage system for the computer system;
identifying, by the computer system, a structure for the information from the request;
creating, by the computer system, a relational database having the structure identified from the request; and
placing, by the computer system, the information for the client device in the relational database, wherein the relational database is located in a memory, wherein the relational database in the memory is accessed by the client device, enabling access to the information in the key value database by client devices that access relational databases with different relational database structures.

2. The method of claim 1 further comprising:
receiving a query from the client device for the information; and
returning a response from the relational database to the client device.

3. The method of claim 1 further comprising:
receiving a query from the client device to change the information in the relational database; and
storing a change to the relational database in the memory.

4. The method of claim 3 further comprising:
writing the change in the memory to the key value database in the storage system in response to an event.

5. The method of claim 1, wherein the request includes at least one of a user identifier, an organization identifier, a client device identifier, or an application identifier.

6. The method of claim 5 further comprising:
identifying a portion of the information accessible by a user from the user identifier, and wherein placing the information for the client device in the relational database in the memory comprises:
placing the portion of the information into the relational database in the memory for the client device.

7. The method of claim 1 further comprising:
identifying a portion of the information for an organization accessible by an application and wherein placing the information for the client device in the relational database in the memory comprises:
placing the portion of the information into the relational database in the memory for the client device.

8. An information access system comprising:
an information manager that receives a request from a client device to access information in a key value database in a storage system for a computer system; identifies a structure for the information from the request; creates a relational database having the structure identified from the request; and places the information for the client device in the relational database, wherein the relational database is located in a memory, wherein the relational database in the memory is accessed by the client device, enabling access to the information in the key value database by client devices that access relational databases with different relational database structures.

9. The information access system of claim 8, wherein the information manager receives a query from the client device for the information and returns a response from the relational database to the client device.

10. The information access system of claim 8, wherein the information manager receives a query from the client device to change the information in the relational database and stores a change to the relational database in the memory.

11. The information access system of claim 10, wherein the information manager writes the change in the memory to the key value database in the storage system in response to an event.

12. The information access system of claim 8, wherein the request includes at least one of a user identifier, an organization identifier, a client device identifier, or an application identifier.

13. The information access system of claim 12, wherein the information manager identifies a portion of the information accessible by a user from the user identifier, and in wherein placing the information for the client device in the relational database in the memory, the information manager places the portion of the information into the relational database in the memory for the client device.

14. The information access system of claim 8, wherein the information manager identifies a portion of the information for an organization accessible by an application, and wherein placing the information for the client device in the relational database in the memory, the information manager places the portion of the information into the relational database in the memory for the client device.

15. A computer program product for accessing information stored in a key value database, the computer program product comprising:
a computer readable storage media;
first program code, stored on the computer readable storage media, for receiving a request from a client device to access the information in the key value database in a storage system for a computer system;
second program code, stored on the computer readable storage media, for identifying a structure for the information from the request;
third program code, stored on the computer readable storage media, for creating a relational database having the structure identified from the request; and
fourth program code, stored on the computer readable storage media, for placing the information for the client device in the relational database, wherein the relational database is located in a memory, wherein the relational database in the memory is accessed by the client device, enabling access to the information in the key value database by client devices that access relational databases with different relational database structures.

16. The computer program product of claim 15 further comprising:
fifth program code, stored on the computer readable storage media, for receiving a query from the client device for the information; and
sixth program code, stored on the computer readable storage media, for returning a response from the relational database to the client device.

17. The computer program product of claim 15 further comprising:
fifth program code, stored on the computer readable storage media, for receiving a query from the client device to change the information in the relational database; and
sixth program code, stored on the computer readable storage media, for storing a change to the relational database in the memory.

18. The computer program product of claim 17 further comprising:
seventh program code, stored on the computer readable storage media, for writing the change in the memory to the key value database in the storage system in response to an event.

19. The computer program product of claim 15, wherein the request includes at least one of a user identifier, an organization identifier, a client device identifier, or an application identifier.

20. The computer program product of claim 19 further comprising:
fifth program code, stored on the computer readable storage media, for identifying a portion of the information accessible by a user from the user identifier, and
wherein the fourth program code comprises:
program code, stored on the computer readable storage media, for placing the portion of the information into the relational database in the memory for the client device.

21. The computer program product of claim 15 further comprising:
fifth program code, stored on the computer readable storage media, for identifying a portion of the information for an organization accessible by an application; and
wherein the fourth program code comprises:
program code, stored on the computer readable storage media, for placing the portion of the information into the relational database in the memory for the client device.
